(19) United States
(12) Patent Application Publication
(10) Pub. No.: US 2024/0102453 A1
(43) Pub. Date: Mar. 28, 2024

(54) HYBRID POLTRUSION PLATES FOR A CONDUCTIVE SPAR CAP OF A WIND TURBINE BLADE

(71) Applicant: LM WIND POWER A/S, Kolding (DK)

(72) Inventors: Lars Bo HANSEN, Kolding (DK); Mahdi BAVILOLIAIE, Kolding (DK)

(21) Appl. No.: 18/266,794

(22) PCT Filed: Dec. 30, 2021
(86) PCT No.: PCT/EP2021/087861

§ 371 Date: Jun. 12, 2023

(30) Foreign Application Priority Data
Dec. 30, 2020 (EP) 20217860.4

(51) Int. Cl. F03D 80/30; B29C 70/88; B29D 99/00; F03D 1/06

(52) U.S. Cl. CPC F03D 80/301; B29C 70/88; B29D 99/0028; F03D 1/0681; B29K 2309/08; B29K 2995/0005

(57) ABSTRACT

The present invention relates to a method of manufacturing a wind turbine blade shell component (38), the method comprising the steps of providing a plurality of abraded pultrusion plates (64) having abraded edges, arranging the abraded pultrusion plates (64) in layers on blade shell material (89) in a mould (77) for the blade shell component, the layers being separated by electrically conductive interlayers, and bonding the abraded pultrusion plates (64) with the blade shell material to form the blade shell component, wherein each pultrusion plate (64) is formed of a pultrusion fibre material comprising glass fibres and carbon fibres. The invention also relates to a reinforcing structure for a wind turbine blade, the reinforcing structure comprising a plurality of pultrusion plates according to the present invention.

### FIELD OF THE INVENTION

The present invention relates to a method of manufacturing a wind turbine blade shell component and to a reinforcing structure, such as a spar cap, for a wind turbine blade, the reinforcing structure comprising a plurality of pultrusion plates.

### BACKGROUND OF THE INVENTION

Wind power provides a clean and environmentally friendly source of energy. Wind turbines usually comprise a tower, generator, gearbox, nacelle, and one or more rotor blades. The wind turbine blades capture kinetic energy of wind using known airfoil principles. Modern wind turbines may have rotor blades that exceed 90 meters in length.

Wind turbine blades are usually manufactured by forming two shell parts or shell halves from layers of woven fabric or fibre and resin. Spar caps or main laminates are placed or integrated in the shell halves and may be combined with shear webs or spar beams to form structural support members. Spar caps or main laminates may be joined to, or integrated within, the inside of the suction and pressure halves of the shell.

As the size of wind turbine blades increases, various challenges arise from the blades being subjected to increased forces during operation, requiring improved reinforcing structures. In some known solutions, pultruded fibrous strips of material are used to design spar caps. Pultrusion is a continuous process in which fibres are pulled through a supply of liquid resin and then heated in a chamber where the resin is cured. Such pultruded strips can be cut to any desired length. As such, the pultrusion process is typically characterized by a continuous process that produces composite parts having a constant cross-section. Thus, a plurality of pultrusions can be vacuum infused together in a mould to form the spar caps.

Typically, a spar cap in a wind turbine blade is made from either carbon pultrusions or glass pultrusions. Carbon fibres are typically lighter than glass fibres by volume and have improved tensile and compressive strength. One of the challenges of wind turbine blade manufacturing is that a lightning protection system of the blade often requires that at least some blade components have a sufficiently high electrical conductivity through the thickness of the components, such as reinforcing sections like spar caps. There is thus an ongoing need for an improved pultruded spar cap and method for incorporating such spar cap in a wind turbine blade.

It is therefore an object of the present invention to provide a wind turbine blade with an improved reinforcing structure, such as a spar cap.

It is another object of the present invention to provide an optimized arrangement of materials used in the manufacture of a spar cap.

It is another object of the present invention to provide a reinforcing structure for a wind turbine blade which is a cost efficient structure and has optimized material characteristics for use in a lightning protection system of the blade.

It is another object of the present invention to provide a suitable reinforcing structure for a wind turbine blade which can be manufactured efficiently.

### SUMMARY OF THE INVENTION

It has been found that one or more of the aforementioned objects can be obtained by providing a method of manufacturing a wind turbine blade shell component, such as a wind turbine shell half, the method comprising the steps of
providing a plurality of abraded pultrusion plates obtained from a first plurality of pultrusion plates, wherein each pultrusion plate in the first plurality of pultrusion plates comprises a top surface, an opposing bottom surface, a first lateral surface and an opposing second lateral surface, wherein obtaining the plurality of abraded pultrusion plates includes abrading each of the first plurality of pultrusion plates by removing at least a part of each of the edges at which the top surface meets the lateral surfaces and the edges at which the bottom surface meets the lateral surfaces,
arranging a first layer of abraded pultrusion plates on a blade shell material in a mould,
arranging a first electrically conductive interlayer on the first layer of abraded pultrusion plates,
arranging a second layer of abraded pultrusion plates on the first interlayer, the second layer being separated from the first layer by the first interlayer
bonding the first and second layers of abraded pultrusion plates with the blade shell material to form the blade shell component,
wherein each pultrusion plate in the first plurality of pultrusion plates is formed of a pultrusion fibre material comprising a plurality of tows of carbon fibre material, and wherein adjoining tows of carbon fibre material are provided along the lateral surfaces of the pultrusion plate.

In some embodiments, the pultrusion plates are made entirely of carbon fibre tows. In some embodiments, the pultrusion plates further comprise a plurality of tows of glass fibre material together with the carbon tows.

The abraded pultrusion plates may be abraded in advance, not as part of the aspects of the invention. In that case, the term “includes” refers to abrading steps that were performed in advance, not actively as part of the aspects of the invention. That is, the abrading steps were included as part of the process of obtaining the abraded pultrusion plates in advance. In some embodiments, the abrading is performed as part of the aspects of the invention.

The present inventors have found that this method allows for tailoring the architecture of a hybrid glass/carbon pultrusion for use in a wind turbine blade spar cap, such that the carbon fibre material is utilized in the best possible way, in particular to enhance the lightning protection properties and structural performance of the blade. The abrading of the edges leads to an improved electrical connection between the interlayer and the layers of abraded pultrusion plates. It was found that the present solution reduces the risk for flaring over the pultrusion spar beam. Thus, structural and lightning protection performance can be enhanced at minimum material cost. Carbon fibres usually have high electrical conductivity and high stiffness per weight. These properties are desirable in the spar cap of a wind turbine blade. However, drawbacks of carbon fibres include the relatively low strain to failure and the comparatively high price per kg. Glass fibres are typically cheaper and have higher strain to failure. However, the electrical conductivity of glass fibres is minimal and stiffness per weight is significantly lower.

In a preferred embodiment, the ratio of carbon fibre material to glass fibre material in the abraded pultrusion plate is between 1/5 to 1/1, preferably 1/4 to 1/1. This was found to provide optimised properties of the abraded pultrusion plate in terms of electrical conductivity and overall stiffness.

The electrically conductive interlayer may for instance be a carbon biax layer, a carbon veil or a glass/carbon hybrid fabric or a glass/carbon hybrid veil. Being arranged between the first layer of abraded pultrusion planks and the second layer of abraded pultrusion planks, the carbon fibre material in the different abraded pultrusion plates is electrically connected, allowing lightning current to be conducted to ground with less resistance and thus less heating.

In some embodiments, removing at least a part of each of the edges at which the top surface meets the lateral surfaces reduces a width of the top surface by 6-30 mm, such as by 10-30 mm, such as by 10-20 mm. Typically, the same amount of material is removed at the two edges where the top surface meets the two lateral surfaces. That is, the top surface is shortened by removing 3-15 mm, such as 5-15 mm, such as 5-10 mm at each of the two edges.

In some embodiments, removing at least a part of each of the edges at which the bottom surface meets the lateral surfaces reduces a width of the bottom surface by 6-30 mm, such as by 10-30 mm, such as by 10-20 mm. Typically, the same amount of material is removed at the two edges where the bottom surface meets the two lateral surfaces. That is, the bottom surface is shortened by removing 3-15 mm, such as 5-15 mm, such as 5-10 mm at each of the two edges.

In some embodiments, the wind turbine blade shell component comprises one or more layers in addition to the first layer and the second layer of abraded pultrusion plates. Interlayers may be included between each pair of adjacent layers or only between some of the layers. Including interlayers between each pair of adjacent layers leads to a better distribution of resin during infusion and better lightning current conduction during a lightning strike.

In some embodiments, the step of removing the at least a part of each of the edges includes steps of:
abrading a first part of the top surface within a first region of the top surface, the first region of the top surface extending from the first lateral surface towards the second lateral surface,
abrading a second part of the top surface within a second region of the top surface, the second region of the top surface extending from the second lateral surface towards the first lateral surface,
abrading a first part of the bottom surface within a first region of the bottom surface, the first region of the bottom surface extending from the first lateral surface towards the second lateral surface,
abrading a second part of the bottom surface within a second region of the bottom surface, the second region of the bottom surface extending from the second lateral surface towards the first lateral surface.

Typically, the first plurality of pultrusion plates comprises pultrusion plates having a rectangular vertical cross-section.

The step of arranging the abraded pultrusion plates on blade shell material in a mould for the blade shell component preferably comprises arranging the abraded pultrusion plates into adjacent stacks of abraded pultrusion plates, wherein adjacent refers to a substantially chordwise direction. These stacks usually extend in a substantially spanwise direction of the shell half, but layers formed by pultrusion plates in the adjacent stacks may be curved in case the surface they are arranged on is curved. This means that two or more plates in a layer are arranged at an angle with respect to each other as opposed to forming a planar layer.

The step of bonding the abraded pultrusion plates with the blade shell material to form the blade shell component usually comprises a resin infusion step in which the abraded pultrusion plates and the blade shell material are infused with a resin, for example in a VARTM process. The interlayers aid transport of resin between the layers of abraded pultrusion plates.

Each abraded pultrusion plate comprises tows or rovings of carbon fibre material and in some embodiments also tows or rovings of glass fibre material. The terms tows and rovings are used interchangeably herein. In some embodiments, each tow comprises a plurality of carbon filaments or glass fibre filaments, wherein each filament comprises an outer layer of sizing. In addition, each abraded pultrusion plate preferably comprises a resin or binding agent which is used in the pultrusion process for joining the various fibre tows into a single pultrusion string. Preferably, each abraded pultrusion plate comprises a matrix of fibre tows arranged in columns and rows, as seen in a vertical cross section of the plate. Thus, pultrusion fibre material may comprise glass fibres, carbon fibres, a resin or binding agent, and optionally additional reinforcing material. Typically, the abraded pultrusion plate has a constant cross-section along its length. The planks may be pre-bent or pre-twisted along their longitudinal axis.

Adjoining tows of carbon fibre material are provided along the entire lateral surfaces of the abraded pultrusion plate, that is, from the top surface to the bottom surface. It is thus particularly preferred that the lateral surfaces of the abraded pultrusion plate are free from glass fibre material.

The abraded pultrusion plates used in the method above are typically made based on pultrusion plates having a rectangular vertical cross section. They are often manufactured at a separate facility but may also be manufactured where the method above is performed.

Each stack of abraded pultrusion plates may comprise 2-30, such as 5-20 abraded pultrusion plates successively arranged on top of each other. Thus, each stack will usually extend in a spanwise direction of the blade. In a midsection between a root end and a tip end, each stack may comprise 8-15 layers of abraded pultrusion plates, whereas towards the root end and towards the tip end the number of layered abraded pultrusion plates may decrease to 1-3. Thus, the stack of abraded pultrusion plates is preferably tapered towards both the root end and the distal end. Such configuration advantageously allows for a profile that is consistent with the thickness profile of the shell. Typically, two or more, or three or more stacks of abraded pultrusion plates are arranged next to each other, adjacent to each other in a substantially chordwise direction. Typically, a resin will be infused in the stack of abraded pultrusion plates. This can, for example, be done using vacuum-assisted resin transfer moulding.

The blade shell component is usually a blade shell half, such as a shell half with a reinforcing structure such as a spar cap. The blade shell material may include one or more fibre layers and/or a gelcoat. The plurality of abraded pultrusion plates will typically extend in a spanwise direction of the shell half or of the blade. Thus, at least some of the abraded pultrusion plates have preferably a length corresponding to 60-95% of the blade length. A polymer resin is typically infused in between the abraded pultrusion plates following the lay-up into the shell half.

In a preferred embodiment, the pultrusion fibre material comprises a plurality of tows of glass fibre material and a plurality of tows of carbon fibre material. Thus, the ratio of numbers of carbon fibre tows to numbers of glass fibre tows in the abraded pultrusion plate is preferably between 1/5 to 1/1, such as 1/4 to 1/1. In a preferred embodiment, each tow comprises 10,000 to 100,000 filaments, preferably 20,000 to 60,000 filaments, of glass or carbon fibre. In some embodiments, each glass fibre tow comprises 1,000 to 10,000 filaments of glass fibre.

In a preferred embodiment, the tows of glass fibre material and the tows of carbon fibre material extend substantially parallel to each other within the abraded pultrusion plate. In a preferred embodiment, the tows of glass fibre material and the tows of carbon fibre material are arranged in an array, preferably a regular array, of rows and columns of tows, as seen in a vertical cross section of the abraded pultrusion plate. The rows will typically extend in a substantially horizontal or chordwise direction, whereas the columns will typically extend in a substantially vertical or flapwise direction. The array of rows and columns of tows will typically be constant over the length of the abraded pultrusion plate.

In a preferred embodiment, the tows of glass fibre material and the tows of carbon fibre material are arranged in a plurality of rows of tows, and optionally a plurality of columns of tows, as seen in a vertical cross section of the abraded pultrusion plate.

In a preferred embodiment, the lateral surfaces of each abraded pultrusion plate are free from glass fibres, preferably by providing a continuous path of adjoining tows of carbon fibre material along the lateral edges of the abraded pultrusion plate, the continuous path of adjoining tows of carbon fibre material extending from the top surface to the opposing bottom surface of the abraded pultrusion plate. In some embodiments, the adjoining tows of carbon fibre material extend from each lateral surface inward over a chordwise or horizontal distance of 2-25 mm, preferably 2-12 mm. In some embodiments, said chordwise or horizontal distance is longer, e.g. 8-12 mm at the top and bottom surfaces of the abraded pultrusion plate, and shorter towards the midpoint of each lateral surface, such as 1-4 mm.

In a preferred embodiment, the plurality of tows of glass fibre material and the plurality of tows of carbon fibre material form a non-random pattern, preferably a symmetrical pattern, as seen in a vertical cross section of the abraded pultrusion plate. Typically, the pattern is constant over the length of the abraded pultrusion plate. In one embodiment, the pattern is a checkerboard/checkerboard-like pattern, for example with alternating glass fibre tows and carbon fibre tows in each column and in each row of the abraded pultrusion plate. Such pattern is found to be comparatively easy to manufacture. In another preferred embodiment, the pattern comprises one more vertical columns of carbon fibre tows extending from the top surface to the bottom surface of the abraded pultrusion plate, as seen in a vertical cross section of the abraded pultrusion plate. It is preferred that the pattern has reflectional symmetry or bilateral symmetry as appearing on the vertical cross section of the abraded pultrusion plate, such that the left and right sides are mirror images of each other.

In a preferred embodiment, the abraded pultrusion plates are arranged into adjacent stacks of abraded pultrusion plates, and a continuous path of adjoining tows of carbon fibre material extends from the top surface of the uppermost abraded pultrusion plate to the bottom surface of the lowermost abraded pultrusion plate of each stack of abraded pultrusion plates. Said continuous path of adjoining tows of carbon fibre material within the stack is preferably an electrically conductive path. Thus, the entire stack in combination with the electrically conductive interlayers may conduct a lightning current from the top surface of the stack to the bottom surface of the stack, preferably in a substantially vertical or flapwise direction, and may also include electrically parallel paths including several sides (lateral surfaces) of several abraded pultrusion plates across the stacks.

It is particularly preferred that the abraded pultrusion plates, and the reinforcing structure comprising the abraded pultrusion plates, do not comprise any isolated tows of carbon fibre material, such as tows of carbon fibre material that are not electrically coupled to another tow of carbon fibre material. Thus, in a particularly preferred embodiment, all tows of carbon fibre material within the abraded pultrusion plate are electrically coupled, i.e. providing a conduction path for electrical energy, such as a lightning current, between the tows of carbon fibre material. This is found to effectively prevent flashovers inside the spar cap when the blade is hit by a lightning strike, thus preventing damage to the abraded pultrusion plate and to the reinforcing structure, such as the spar cap.

In some embodiments, the stacked abraded pultrusion plates are pre-bonded together prior to being bonded to the blade shell, with electrically conductive interlayers in between layers as described above. Alternatively, the stacked abraded pultrusion plates are co-bonded with the blade shell materials. In a preferred embodiment, the stacked abraded pultrusion plates are bonded with the blade shell material using an adhesive or in a vacuum assisted resin transfer moulding (VARTM) process.

Usually, the top and bottom surfaces of the pultrusion plates face opposing flapwise directions, whereas the lateral surface typically faces towards the trailing edge and towards the leading edge of the blade half, respectively. The present inventors have found that an efficient lightning protection system benefits from the conductive carbon fibre materials being connected electrically and/or physically throughout the reinforcing structure, in particular in the vertical or flapwise direction, along the lateral edges of the stacked abraded pultrusion plates. This ensures that flashovers do not occur inside the spar cap when the blade is hit by a lightning strike and reduces heating in the centre of each pultrusion plate. Thus, it is advantageous that the electrical conductivity through the thickness of the abraded pultrusion plates is relatively high. Thus, the continuous path of adjoining tows of carbon fibre material extending from the top surface to the opposing bottom surface of the abraded pultrusion plate may advantageously provide an electrically conductive path, in particular for lightning strikes, throughout the vertical direction of the abraded pultrusion plate and through the interlayers. In a preferred embodiment, the continuous path of adjoining tows of carbon fibre material extends substantially vertically within the abraded pultrusion plate or includes several electrically parallel paths.

In a preferred embodiment, adjoining tows of carbon fibre material means adjacent tows of carbon fibre material that are spaced apart by a distance not more than 100 μm, such as not more than 50 μm, preferably not more 30 μm, such as not more than 20 μm, preferably not more than 10 μm. Such maximum distances are found to provide a sufficiently electrically conductive path between adjoining tows of carbon fibre material.

In a particularly preferred embodiment, the distance between adjoining tows of carbon fibre material is less than 100 μm, preferably less than 50 μm, more preferably less than 20 μm, most preferably less than 10 μm. In some embodiments, the distance between adjoining tows of carbon fibre material is zero.

In a preferred embodiment, adjoining tows of carbon fibre material are provided along the top surface of each abraded pultrusion plate. In another preferred embodiment, adjoining tows of carbon fibre material are provided along the bottom surface of each abraded pultrusion plate. The adjoining tows of carbon fibre material may extend from the top and from the bottom surface, respectively, inward along a vertical distance of 1-3 mm, such as 1.5-2.0 mm.

In a preferred embodiment, several adjacent columns of adjoining tows of carbon fibre material are provided along the entire lateral surfaces of the abraded pultrusion plate. This provides an additional electrical path between the lateral surface of individual pultrusion plates and may provide additional electrical contact between the interlayer and the pultrusion plates.

In a preferred embodiment, a continuous, preferably substantially horizontal, row of adjoining tows of carbon fibre material extends between the lateral surfaces, said continuous row being spaced apart from the top surface and from the bottom surface of the abraded pultrusion plate.

In a preferred embodiment, the abraded pultrusion plate comprises a checkerboard/checkerboard-like pattern of tows of carbon fibre material and tows of glass fibre material in a centre region of the abraded pultrusion plate, as seen in a vertical cross section of the abraded pultrusion plate.

In another aspect, the present invention relates to an abraded pultrusion plate comprising a top surface, an opposing bottom surface, a first lateral surface and an opposing second lateral surface, wherein the abraded pultrusion plate has abraded edges and wherein the abraded pultrusion plate is formed of a pultrusion fibre material comprising a plurality of tows of glass fibre material and a plurality of tows of carbon fibre material, and wherein adjoining tows of carbon fibre material are provided along the entire lateral surfaces of the abraded pultrusion plate.

In some embodiments, the abraded pultrusion plate has been obtained by abrading a first pultrusion plate, such as a pultrusion plate with a rectangular vertical cross section, the first pultrusion plate comprising a top surface, an opposing bottom surface, a first lateral surface and an opposing second lateral surface, wherein the first pultrusion plate is formed of a plurality of tows of carbon fibre material, and wherein adjoining tows of carbon fibre material are provided along the entire lateral surfaces of the pultrusion plate, and wherein abrading the first pultrusion plates to obtain the abraded pultrusion plate includes removing at least a part of each of the edges at which the top surface meets the lateral surfaces and the edges at which the bottom surface meets the lateral surfaces.

Typically, the first pultrusion plate had a rectangular vertical cross-section.

In some embodiments, the step of removing at least a part of each of the edges includes steps of:
abrading a first part of the top surface within a first region of the top surface, the first region of the top surface extending from the first lateral surface towards the second lateral surface,
abrading a second part of the top surface within a second region of the top surface, the second region of the top surface extending from the second lateral surface towards the first lateral surface,
abrading a first part of the bottom surface within a first region of the bottom surface, the first region of the bottom surface extending from the first lateral surface towards the second lateral surface,
abrading a second part of the bottom surface within a second region of the bottom surface, the second region of the bottom surface extending from the second lateral surface towards the first lateral surface.

In some embodiments, a total longitudinal length of each of the abraded parts is in the range [Lₚ-2000 mm, Lₚ₁], such as in the range [Lₚ-1500 mm, Lₚ₁-100 mm], where Lₚ is a longitudinal length of the abraded pultrusion plate. One or both longitudinal ends of the abraded pultrusion plates may be chamfered and abrading may not be needed or may even reduce the strength of the chamfered ends and must therefore be avoided.

The removing of material may for instance result in rounded edges or additional facets connecting the top surface and the bottom surface with the lateral surfaces.

In a preferred embodiment, the tows of glass fibre material and the tows of carbon fibre material are arranged in a plurality of rows of tows, and optionally a plurality of columns of tows, as seen in a vertical cross section of the abraded pultrusion plate.

In a preferred embodiment, the lateral surfaces of the abraded pultrusion plate are free from glass fibres, preferably by providing a continuous path of adjoining tows of carbon fibre material along the lateral edges of the abraded pultrusion plate, the continuous path of adjoining tows of carbon fibre material extending from the top surface to the opposing bottom surface of the abraded pultrusion plate.

In a preferred embodiment, the plurality of tows of glass fibre material and the plurality of tows of carbon fibre material form a non-random pattern, preferably a symmetrical pattern, as seen in a vertical cross section of the abraded pultrusion plate.

In another aspect, the present invention relates to a reinforcing structure for a wind turbine blade, the reinforcing structure comprising a plurality of abraded pultrusion plates according to the present invention.

In another aspect, the present invention relates to an abraded pultrusion plate. The abraded pultrusion plate has been obtained by abrading a first pultrusion plate having a top surface, an opposing bottom surface, a first lateral surface and an opposing second lateral surface, wherein the first pultrusion plate is formed of a pultrusion fibre material comprising a plurality of tows of carbon fibre material (and optionally a plurality of tows of glass fibre material) and wherein adjoining tows of carbon fibre material are provided along the entire lateral surfaces of the first pultrusion plate. Furthermore, the abrading of the first pultrusion plate to obtain the abraded pultrusion plate has includes removing at least a part of each of the edges at which the top surface meets the lateral surfaces and the edges at which the bottom surface meets the lateral surfaces in the first pultrusion plate, and wherein adjoining tows of carbon fibre material are provided along the entire top surface and/or along the entire bottom surface of the pultrusion plate. The present invention also relates to a method of manufacturing a wind turbine blade shell component, the method comprising the steps of providing a plurality of abraded pultrusion plates, wherein each abraded pultrusion plate comprises a top surface, an opposing bottom surface and two lateral surfaces, arranging the pultrusion plates on a blade shell material in a mould for the blade shell component, and bonding the pultrusion plates with the blade shell material to form the blade shell component, wherein each abraded pultrusion plate is formed of a pultrusion fibre material comprising a plurality of tows of glass fibre material and a plurality of tows of carbon fibre material, and wherein adjoining tows of carbon fibre material are provided along the entire top surface and along the entire bottom surface of the pultrusion plate. The abraded pultrusion plates may be obtained for instance from rectangular pultrusion plates as described above.

The top and bottom surfaces of the pultrusion plate may be covered by peel ply.

In a preferred embodiment, the abraded pultrusion plates have a longitudinal length corresponding to an entire length of a spar cap for a wind turbine blade shell. In a preferred embodiment, the pultrusion plates are bonded with the blade shell material in a resin infusion process.

In some embodiments, a total longitudinal length of each of the abraded parts is at least half a longitudinal length, Lₚ₁ of the abraded pultrusion plate.

In some embodiments, a total longitudinal length of each of the abraded parts is in the range [Lₚ-2000 mm, Lₚ₁], such as in the range [Lₚ-1500 mm, Lₚ₁-100 mm], where Lₚ is a longitudinal length of the abraded pultrusion plate. One or both longitudinal ends of the abraded pultrusion plates may be chamfered and abrading may not be needed or may even reduce the strength of the chamfered ends and must therefore to be avoided.

The removing of material may for instance result in rounded edges or additional facets connecting the top surface and the bottom surface with the lateral surfaces.

In one aspect, the present invention relates to a wind turbine blade shell component, such as a shell half, obtainable by one of the methods of the present invention.

The present invention also relates to a wind turbine blade having a pressure side shell and a suction side shell, wherein the suction and pressure side shells are joined along a leading and trailing edge of the blade. One or both of the suction and pressure side shell components further include a reinforcing structure, such as a spar cap bonded to an interior surface of the shell, wherein the spar cap includes a plurality of abraded pultrusion plates according to the present invention. The abraded pultrusion plates may have a continuous unbroken length along an entire length of the spar cap.

In a preferred embodiment, the abraded pultrusion plate has an almost rectangular cross section, except parts have been removed from at least a part of each of the edges at which the top surface meets the lateral surfaces and the edges at which the bottom surface meets the lateral surfaces as described above.

In a preferred embodiment, the pultrusion plate has the shape of a rectangular cuboid, except the parts that have been removed from at least a part of each of the edges at which the top surface meets the lateral surfaces and the edges at which the bottom surface meets the lateral surfaces, as described above.

The abraded pultrusion plate has a length, which typically extends in a substantially spanwise direction when the pultrusion plate is arranged in the blade shell. The pultrusion plate also has a width, which typically extends in a substantially chordwise direction when the abraded pultrusion plate is arranged in the blade shell. The abraded pultrusion plate also has a height or thickness, which typically extends in a substantially flapwise direction when the abraded pultrusion plate is arranged in the blade shell. The thickness of the abraded pultrusion plate is preferably between 3 and 10 mm, more preferably between 4 and 7 mm. The length of the plate is typically its largest dimension. The length of the plate extends in the same direction as its longitudinal axis.

The length of the abraded pultrusion plate is typically between 50 and 150 meters, preferably between 50 and 100 meters, more preferably between 70 and 100 meters. The height/thickness of the abraded pultrusion plate is preferably between 2 and 10 millimeters, preferably between 3 and 7 millimeters, most preferably between 4 and 6 millimeters. The width of the plate is preferably between 20 and 300 millimeters, most preferably between 80 and 150 millimeters. In a preferred embodiment, the reinforcing structure, such as the spar cap, comprises between 1 and 15 stacks of abraded pultrusion plates arranged next to each other, more preferably between 3 and 9 stacks. Each stack may comprise up to 20 abraded pultrusion plates arranged on top of each other, such as 2-20 abraded pultrusion plates or 2-10 abraded pultrusion plates. Thus, each reinforcing section, such as each spar cap, may comprise 10 to 200 abraded pultrusion plates.

The pultrusion fibre material comprises a plurality of tows or rovings of carbon fibre material and optionally a plurality of tows or rovings of glass fibre material. Thus, each abraded pultrusion plate may comprise 50-300 tows of fibre material in total, preferably 25-180 tows of fibre material. It is preferred that 25-50% of the tows of fibre material are tows of carbon fibre material. Thus, the tows of carbon fibre material may account for 25-50% of all tows in an abraded pultrusion plate, whereas the tows of glass fibre material may account for 50-75% of all tows of fibre material. The tows will usually extend in the length direction of the abraded pultrusion plate, i.e. substantially parallel to its longitudinal axis, or parallel to the spanwise direction when arranged in the blade shell.

In a preferred embodiment, the tows of glass fibre material and the tows of carbon fibre material are arranged in a regular array or regular grid of rows and columns of tows, as seen in a vertical cross section of the abraded pultrusion plate. The abraded pultrusion plate preferably comprises at least 10 rows and at least 10 columns of tows.

All features and embodiments discussed above with respect to the method of manufacturing a wind turbine blade shell component likewise apply to the abraded pultrusion plate or to the reinforcing structure of the present invention and vice versa.

In another aspect, the present invention relates to a reinforcing structure for a wind turbine blade, the reinforcing structure comprising a plurality of abraded pultrusion plates according to the present invention arranged in layers separated by electrically conducting interlayers. The reinforcing structure will typically be a spar cap or a main laminate. In some embodiments, the reinforcing structure comprises a box spar. In other embodiments, the reinforcing structure comprises a spar beam. In a preferred embodiment, the elongate reinforcing structure is a spar structure, such as a spar cap, a spar beam or a box spar. It is preferred that the reinforcing structure extends along the blade in a spanwise direction. Typically, the reinforcing structure will extend over 60-95% of the blade length. The wind turbine blade is usually manufactured from two shell halves, a pressure side shell half and a suction side shell half. Preferably, both shell halves comprise an elongate reinforcing structure, such as a spar cap or a main laminate, according to the present invention.

In another aspect, the present invention relates to a wind turbine blade or to a wind turbine blade component comprising a reinforcing structure according to the present invention, or to a wind turbine blade shell component obtainable by the afore-mentioned method of manufacturing a wind turbine blade shell component. In another aspect, the present invention relates to a wind turbine blade shell component comprising a plurality of abraded pultrusion plates according to the present invention arranged in layers separated by electrically conducting interlayers.

The present invention also relates to a lightning protection system for a wind turbine blade, the lightning protection system comprising a lightning conductor, such as a cable, for example a copper cable, disposed at least partially in the interior of the blade, one or more electrically conductive lightning receptors disposed on one or more of the surfaces of the blade, wherein the one or more electrically conductive lightning receptors are electrically connected to a plurality of abraded pultrusion plates according to the present invention arranged in layers separated by electrically conducting interlayers, or to a reinforcing structure, such as a spar cap, of the present invention. In another aspect, the present invention relates to a wind turbine blade comprising a lightning protection system as described above, i.e. the lightning protection system comprising a lightning conductor, such as a cable, for example a copper cable, disposed at least partially in the interior of the blade, one or more electrically conductive lightning receptors disposed on one or more of the surfaces of the blade, wherein the one or more electrically conductive lightning receptors are electrically connected to a plurality of abraded pultrusion plates according to the present invention, or to a reinforcing structure, such as a spar cap, of the present invention.

The shell halves will typically be produced by infusing a fibre lay-up of fibre material with a resin such as epoxy, polyester or vinyl ester. Usually, the pressure side shell half and the suction side shell half are manufactured using a blade mould. Each of the shell halves may comprise spar caps or main laminates provided along the respective pressure and suction side shell members as reinforcing structures. The spar caps or main laminates may be affixed to the inner faces of the shell halves.

The spar structure is preferably a longitudinally extending load carrying structure, preferably comprising a beam or spar box for connecting and stabilizing the shell halves. The spar structure may be adapted to carry a substantial part of the load on the blade. In some embodiments, the reinforcing structure is arranged within the pressure side shell half. In other embodiments, the reinforcing structure is arranged within the suction side shell half.

In a preferred embodiment, the pressure side shell half and the suction side shell half of the blade are manufactured in respective mould halves, preferably by vacuum assisted resin transfer moulding. According to some embodiments, the pressure side shell half and the suction side shell half each have a longitudinal extent L of 50-110 m, preferably 60-90 m.

According to some embodiments, the method further comprises a step of arranging one or more shear webs in at least one of the shell halves, usually at the location of the reinforcing structure. Each shear web may comprise a web body, a first web foot flange at a first end of the web body, and a second web foot flange at a second end of the web body. In some embodiments, the shear webs are substantially I-shaped. Alternatively, the shear webs may be substantially C-shaped.

In another aspect, the present invention relates to a pultrusion process for manufacturing the abraded pultrusion plate of the present invention, and to an abraded pultrusion plate obtainable by said pultrusion process and the abrading of the edges described above. Said pultrusion process preferably comprises the provision of a plurality of bobbins carrying respective tows of carbon fibre material. Each tow is advantageously pulled through guide plates, a resin bath, and a heated die by a pulling mechanism. In some embodiments, the process further comprises provision of a plurality of bobbins carrying respective tows of glass fibre material combining with the carbon fibre material. The continuous pultrusion string can be cut into individual pultrusion plates with a length of between 30-200 meters, preferably 50-100 meters, by a cutter. The shaped impregnated plates are then advantageously cured. The guide plates and/or the die may take the form of a spreader or inlet comprising multiple apertures, each aperture receiving a respective carbon fibre tow or glass fibre tow. The apertures can be spaced, and they are located so as to guide the fibre tows to form a desired pattern of glass fibre tows and carbon fibre tows in the pultrusion plates.

As used herein, the term “vertical cross section of the pultrusion plate” refers to a cross section of the pultrusion plate on a plane perpendicular to its longitudinal axis, i.e. the axis along the length direction of the pultrusion plate, which is usually the direction in which the pultrusion plate has its greatest extension. When arranged in the blade shell, the longitudinal axis or the length extension of the abraded pultrusion plate will usually coincide substantially with a spanwise direction of the blade. The length along the longitudinal axis is also referred to as the longitudinal length.

As used herein, the term “spanwise” is used to describe the orientation of a measurement or element along the blade from its root end to its tip end. In some embodiments, spanwise is the direction along the longitudinal axis and longitudinal extent of the wind turbine blade.

As used herein, the term “horizontal” refers to a direction that is substantially parallel to the chord of the blade when the abraded pultrusion plates are arranged in the blade shell. The vertical direction is substantially perpendicular to the horizontal direction, extending in a substantially flapwise direction of the blade.

### DESCRIPTION OF THE INVENTION

The invention is explained in detail below with reference to an embodiment shown in the drawings, in which

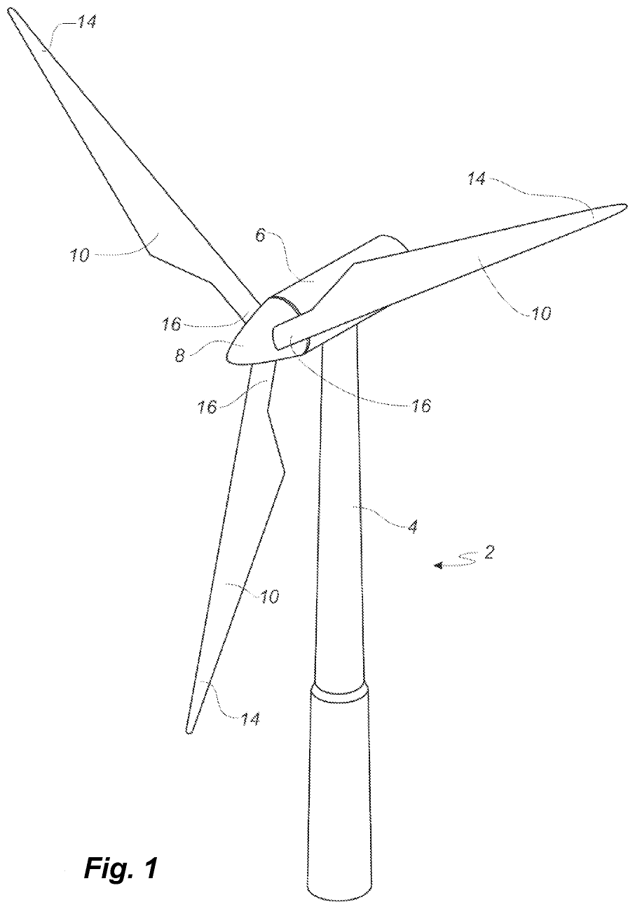

FIG. 1 shows a wind turbine,

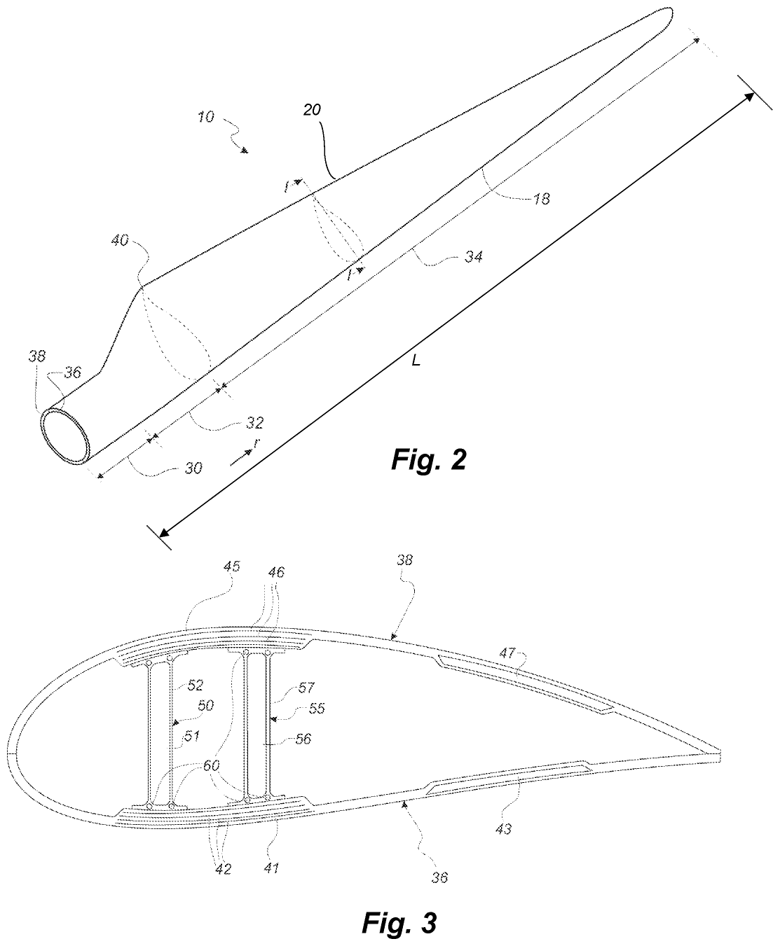

FIG. 2 shows a schematic view of a wind turbine blade,

FIG. 3 shows a schematic view of a cross-section of a wind turbine blade,

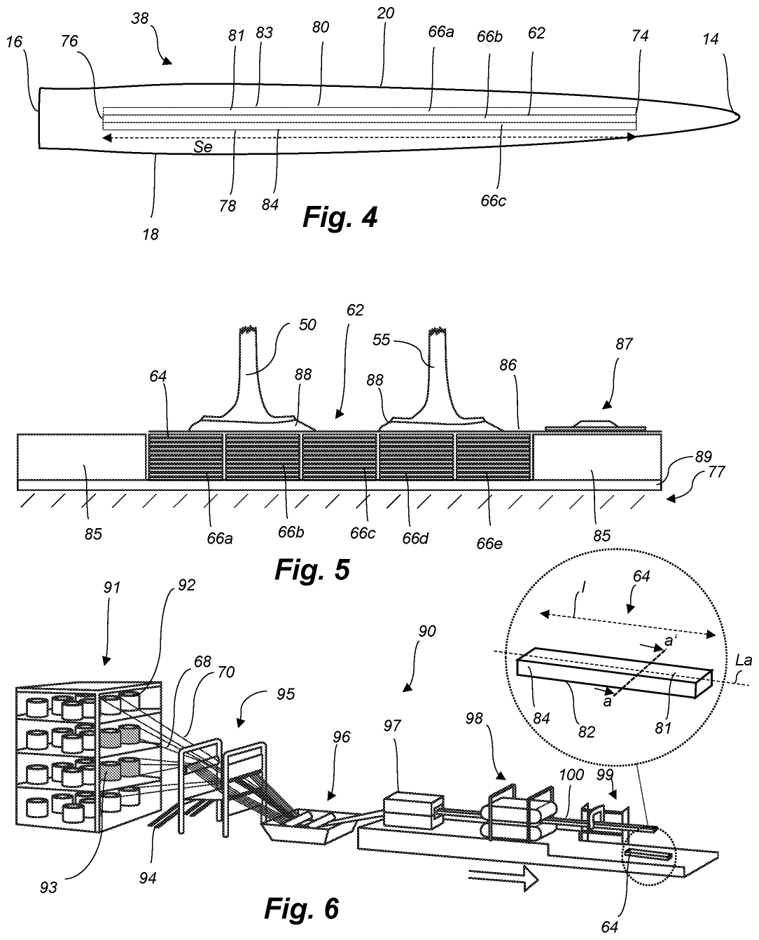

FIG. 4 is a schematic top view of a shell half of a wind turbine blade according to the present invention,

FIG. 5 is a schematic vertical cross section through part of a shell half with a reinforcing structure of the present invention,

FIG. 6 illustrates a pultrusion process for manufacturing the pultrusion plates of the present invention,

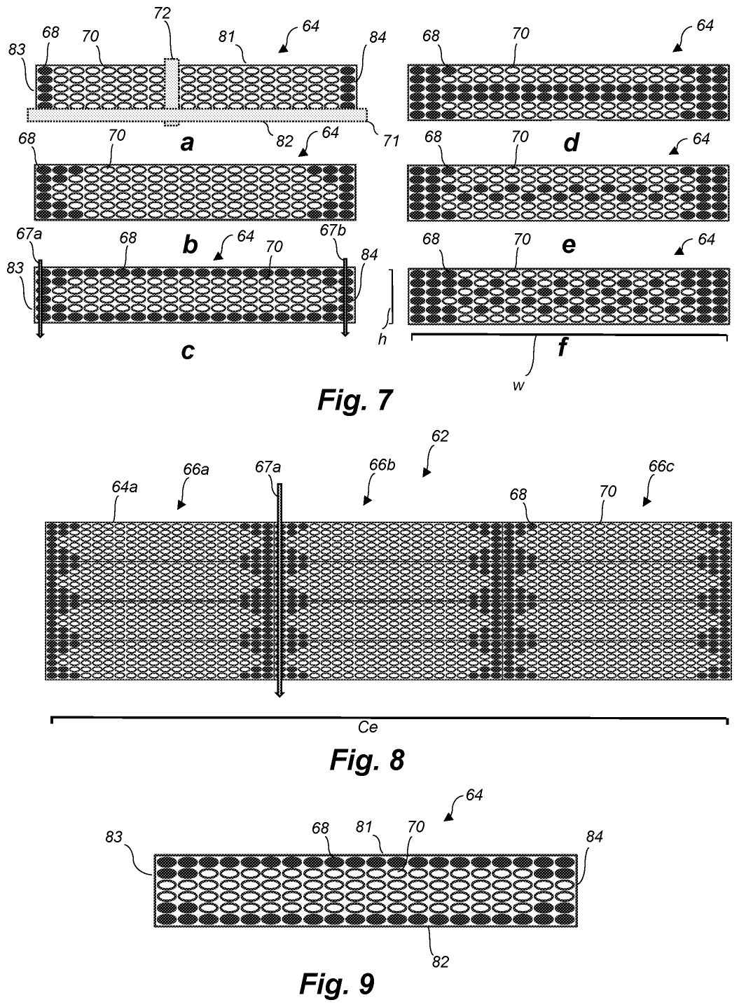

FIGS. 7a-7f is a schematic vertical cross sectional view of different embodiments of the pultrusion plate of the present invention,

FIG. 8 is a vertical cross sectional view of a reinforcing structure of the present invention,

FIG. 9 is a schematic vertical cross sectional view of a pultrusion plate according to another aspect of the present invention,

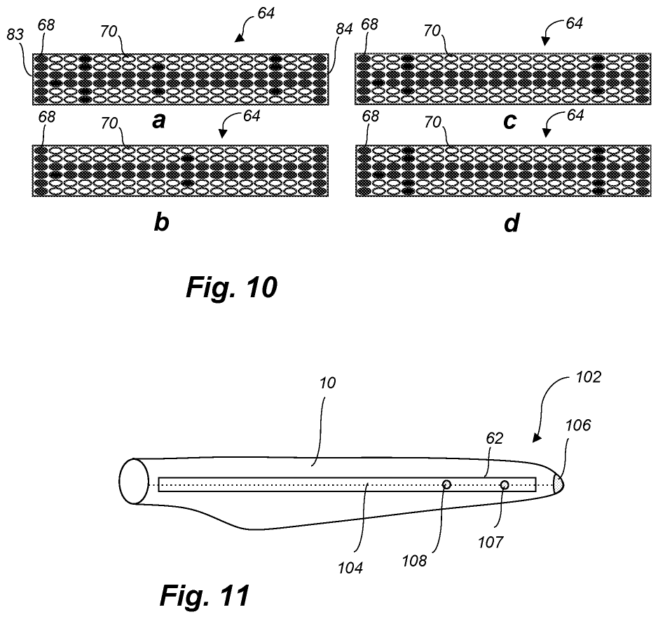

FIG. 10 is a schematic vertical cross sectional view of additional embodiments of the pultrusion plate of the present invention,

FIG. 11 is a schematic illustration of a lightning protection system of the present invention,

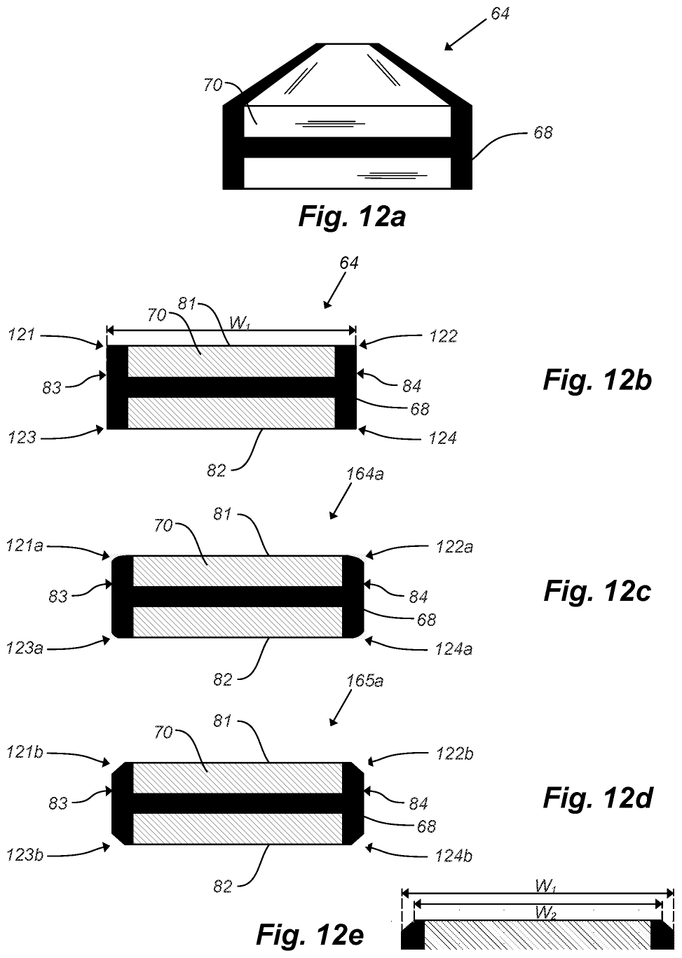

FIGS. 12a-12e illustrate provision of an abraded pultrusion plate,

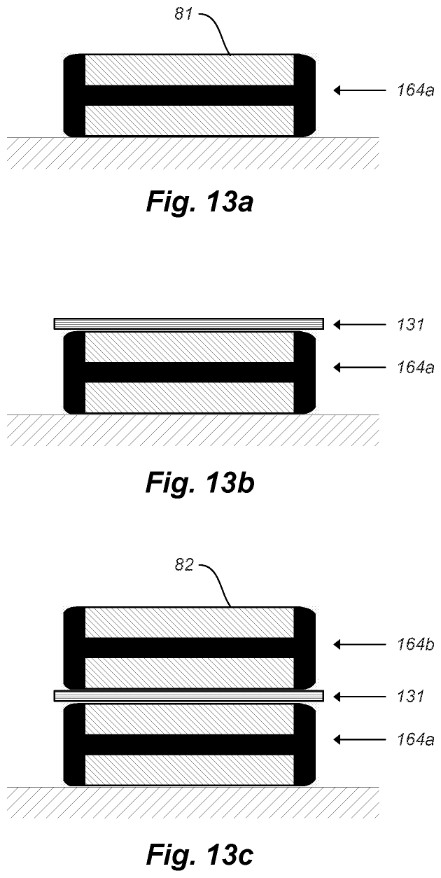

FIGS. 13a-13c illustrate provision of a spar cap structure from a plurality of abraded pultrusion plates,

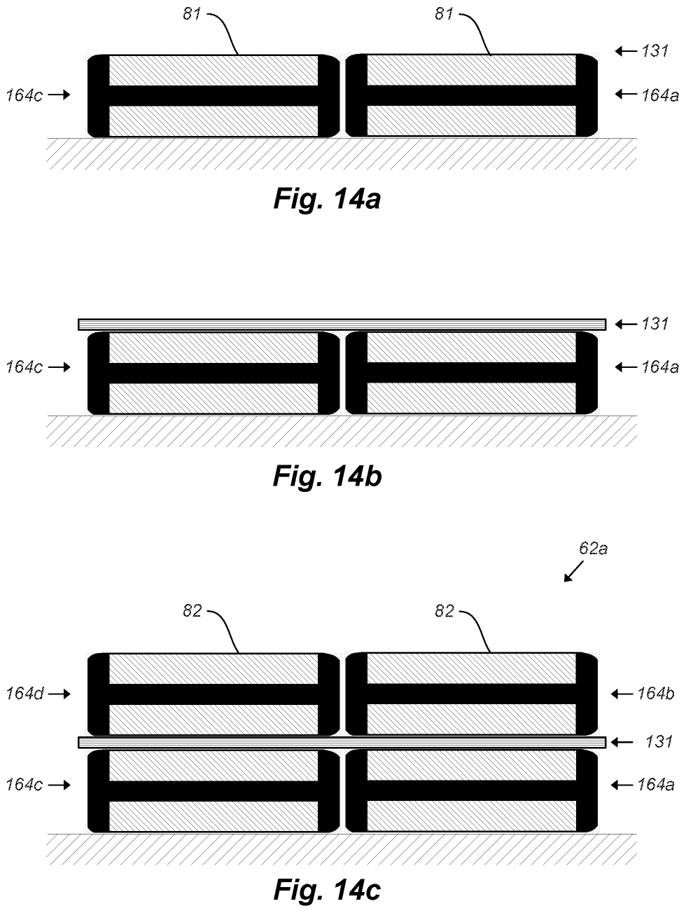

FIGS. 14a-14c illustrate provision of a spar cap structure from a plurality of abraded pultrusion plates,

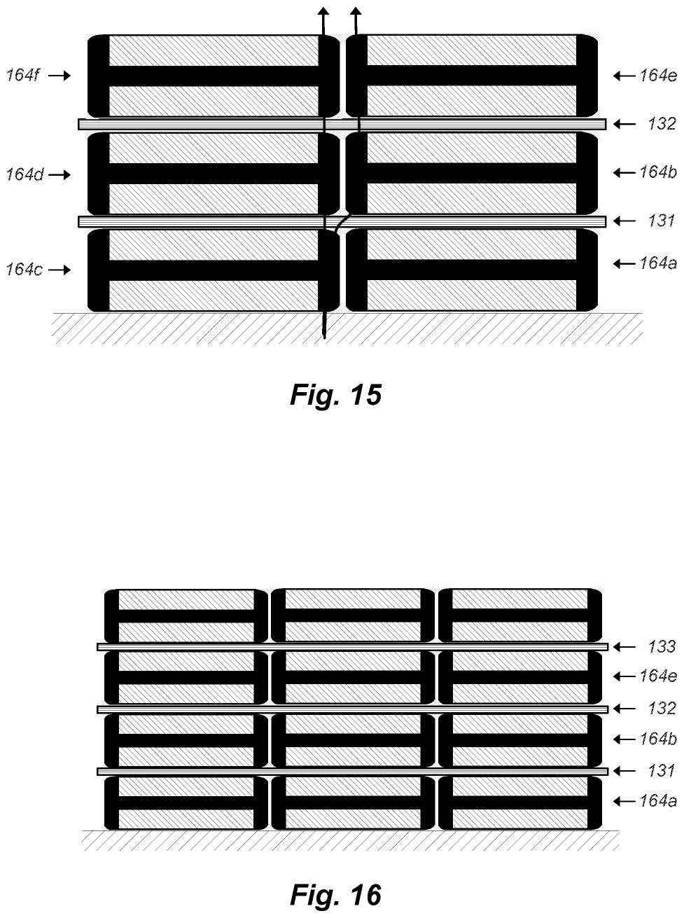

FIG. 15 illustrates a spar cap made from a plurality of abraded pultrusion plates,

FIG. 16 illustrates a spar cap made from a plurality of abraded pultrusion plates.

### DETAILED DESCRIPTION OF THE FIGURES

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance rfrom the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34. FIG. 2 also illustrates the longitudinal extent L, length or longitudinal axis of the blade.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part 36 and a suction side shell part 38 that are glued to each other along bond lines at the leading edge 18 and the trailing edge of the blade 20.

FIG. 3 shows a schematic view of a cross section of the blade along the line I-I shown in FIG. 2. As previously mentioned, the blade 10 comprises a pressure side shell part 36 and a suction side shell part 38. The pressure side shell part 36 comprises a spar cap 41, also called a main laminate, which constitutes a load bearing part of the pressure side shell part 36. The spar cap 41 comprises a plurality of fibre layers 42 mainly comprising unidirectional fibres aligned along the longitudinal direction of the blade in order to provide stiffness to the blade. The suction side shell part 38 also comprises a spar cap 45 comprising a plurality of fibre layers 46. The pressure side shell part 36 may also comprise a sandwich core material 43 typically made of balsawood or foamed polymer and sandwiched between a number of fibre-reinforced skin layers. The sandwich core material 43 is used to provide stiffness to the shell in order to ensure that the shell substantially maintains its aerodynamic profile during rotation of the blade. Similarly, the suction side shell part 38 may also comprise a sandwich core material 47.

The spar cap 41 of the pressure side shell part 36 and the spar cap 45 of the suction side shell part 38 are connected via a first shear web 50 and a second shear web 55. The shear webs 50, 55 are in the shown embodiment shaped as substantially I-shaped webs. The first shear web 50 comprises a shear web body and two web foot flanges.

The shear web body comprises a sandwich core material 51, such as balsawood or foamed polymer, covered by a number of skin layers 52 made of a number of fibre layers. The blade shells 36, 38 may comprise further fibre-reinforcement at the leading edge and the trailing edge. Typically, the shell parts 36, 38 are bonded to each other via glue flanges.

FIG. 4 is a schematic top view of a shell half 38 of a wind turbine blade according to the present invention, illustrating the location of a reinforcing structure 62 having a spanwise extent Se. In the illustrated embodiment, the reinforcing structure 62 comprises three adjacent stacks 66a, 66b, 66c of pultrusion plates. As seen in FIG. 4, the elongate reinforcing structure 62 extends in a substantially spanwise direction of the blade, with adjacent stacks 66a, 66b, 66c of pultrusion plates. The elongate reinforcing structure 62 has a tip end 74, closest to the tip end of the blade, and a root end 76, closest to the root end of the blade. The elongate reinforcing structure also comprises a spanwise extending front edge 78, which is closest to the leading edge 18 of the blade, and a spanwise extending rear edge 80, which is closest to the trailing edge 20 of the blade.

FIG. 5 is a schematic vertical cross section through part of a shell half with a reinforcing structure 62 of the present invention, as seen from the root end of the blade. The reinforcing structure 62, such as a spar cap, comprises a plurality of pultrusion plates 64 according to the present invention, arranged in adjacent stacks 66a-e, which are arranged on blade shell material 89 in mould 77 for the blade shell component, such as a shell half. The stacked pultrusion plates 64 are then bonded with the blade shell material 89 to form the blade shell component, such as the shell half with the spar cap. Core material 85 is arranged on either chordwise side of the reinforcing structure 62. A first shear web 50 and a second shear web 55 are placed on the spar cap 62 via respective bond lines 88. The stacks 66a-e may be covered by a carbon biax layer 86 or a carbon veil or a glass/carbon hybrid fabric or a glass/carbon hybrid veil extending towards current connection terminal 87 of a lightning protection system.

FIG. 6 illustrates a pultrusion process for manufacturing the pultrusion plates 64 of the present invention. The pultrusion process makes use of a pultrusion system 90 which comprises a portion for receiving a plurality of bobbins 92 each supplying a tow of glass fibre material 70 and a plurality of bobbins 93 each supplying a tow of carbon fibre material 68 from a creel 91. Additional reinforcement material 94 may be provided. The tows 68, 70 are pulled through guide plates 95, resin bath 96, and heated die 97 by a pulling mechanism 98. The pultrusion string 100 is cut into individual pultrusion plates 64 by cutter 99. The shaped impregnated fibres are cured and can optionally be wound onto a roll. The guide plates and/or the die may take the form of a spreader or inlet comprising multiple apertures, each aperture receiving a respective carbon fibre tow or glass fibre tow. The apertures can be spaced, and they are located so as to guide the fibre tows to form a desired pattern of glass fibre tows and carbon fibre tows in the pultrusion plates 64. The enlarged view of the pultrusion plate 64 in FIG. 6 also illustrates its longitudinal axis La and its length l. The height/thickness h and width w of the pultrusion plate are illustrated in FIG. 8, see plate 64f.

Various of the patterns of the present invention are illustrated in FIG. 7, which is a schematic vertical cross sectional view of different embodiments of the pultrusion plate 64 of the present invention, taken along the line a-a′ in FIG. 6. Each pultrusion plate 64 in the various embodiments illustrated in FIGS. 7a-f comprises a plurality of tows of glass fibre material 70, indicated as white elliptical shapes, and a plurality of tows of carbon fibre material 68, indicated as black elliptical shapes. As illustrated in FIG. 7a, the tows of glass fibre material 70 and the tows of carbon fibre material 68 are arranged in an array of rows 71 and columns 72 of tows, as seen in a vertical cross section of the pultrusion plate.

As illustrated in FIG. 7a, each pultrusion plate comprises a top surface 81, an opposing bottom surface 82 and two lateral surfaces 83, 84, wherein adjoining tows of carbon fibre material are provided along the lateral surfaces 83, 84. This provides respective continuous paths 67a, 67b of adjoining tows of carbon fibre material extending from the top surface 81 to the opposing bottom surface 82 of the pultrusion plate 64 along the lateral surfaces.

As seen in the various embodiments of FIG. 7, the plurality of tows of glass fibre material 70 and the plurality of tows of carbon fibre material 68 form a non-random pattern, preferably a symmetrical pattern, as seen in a vertical cross section of the pultrusion plate 64. FIG. 7a shows an embodiment where adjoining tows of carbon fibre material are only provided along the lateral surfaces 83, 84. In FIG. 7b, the carbon tows additionally extend along part of the upper and lower surfaces 81, 82, to some extent from the lateral surfaces 83, 84 towards the centre. In the embodiment of FIG. 7c, the carbon tows additionally extend along the upper and lower surfaces 81, 82 across the entire width of the pultrusion plate. The embodiment illustrated in FIG. 7d comprises several rows of adjoining carbon tows 68 along the lateral surfaces, as well as a continuous line of carbon tows extending between the lateral edges within the pultrusion plate. A similar configuration is shown in FIG. 7e, wherein the centre line is somewhat more scattered. Finally, FIG. 7f illustrates an embodiment in which several rows of adjoining carbon tows 68 are provided along the lateral surfaces, and in addition a checkerboard pattern is provided in a centre region of the pultrusion plate 64.

FIG. 8 is a schematic vertical cross sectional view of a reinforcing structure 62 of the present invention, such as a spar cap comprising three chordwise adjacent stacks 66a-c of four pultrusion plates 64 per stack. Several continuous paths of adjoining tows of carbon fibre material extend from the top surface of the reinforcing structure 62 to its bottom surface as illustrated at 67a by way of the adjoining carbon tows provided at the lateral edges of the individual plates 64. Ce is the chordwise extent of reinforcing structure.

FIG. 9 is a cross sectional view of a pultrusion plate 64 according to another aspect of the present invention. Here, adjoining tows of carbon fibre material 68 are provided along the top surface 81 and the bottom surface 82 of the pultrusion plate, whereas the lateral edges 83, 84 comprise both carbon fibre tows and glass fibre tows. Thus, a conductive path of adjoining carbon fibre tows is provided in a horizontal direction.

FIG. 10 is a schematic vertical cross sectional view of yet additional embodiments of the pultrusion plate of the present invention. Again, the plurality of tows of glass fibre material 70 and the plurality of tows of carbon fibre material 68 form a non-random pattern as seen in a vertical cross section of the pultrusion plate 64. In each of FIGS. 10a-d, adjoining tows of carbon fibre material are provided along the lateral surfaces 83, 84. Also, a continuous line of carbon tows extends through the centre, between the lateral edges of the pultrusion plate. Furthermore, one or more vertically extending columns of adjoining tows of carbon fibre material are provided closer to the middle of the pultrusion plate, some of which extend all the way from the top surface to the bottom surface, see FIGS. 10a, d, and some of which extend only to the top surface, but not to the bottom surface, see FIG. 10c. FIG. 10b shows an embodiment wherein a vertical column extends at the centre of the plate, however, without extending all the way to the top surface or to the bottom surface.

FIG. 11 is a schematic illustration of a lightning protection system of the present invention. The lightning protection system 102 comprises a lightning conductor 104, preferably a down conductor, disposed at least partially in the interior of the blade 10. A tip lightning receptor 106 and two side lightning receptors 107, 108 are disposed on or in one or more of the outer surfaces of the blade 10, wherein the electrically conductive lightning receptors 106, 107, 108 are electrically connected to a spar cap 62 of the present invention.

FIGS. 12a-12e illustrate obtaining an abraded pultrusion plate from an unabraded pultrusion plate. FIG. 12a illustrates a perspective view of a pultrusion plate 64 similar to the pultrusion plate 64 shown in FIG. 7d. For simplicity, the individual tows are not shown. FIG. 12b is the vertical cross section of the pultrusion plate in FIG. 12a, showing the carbon fibre material 68 in black and the glass fibre material 70 hatched.

The pultrusion plate shown in FIGS. 12a-12b is unabraded and has a rectangular vertical cross-section. The top surface 81 meets the lateral surfaces 83 and 84, forming two corresponding edges 121 and 122. Similarly, bottom surface 82 meets the lateral surfaces 83 and 84, forming two corresponding edges 123 and 124. The width W₁ of the top surface 81 (and the bottom surface (82)) is illustrated in FIG. 12b.

FIG. 12c shows an abraded pultrusion plate 164a resulting from abrading the edges 121-124. In this example, the abrading results in rounded edges 121a-124a as shown in FIG. 12c. The removal of parts of the edges shortens the top surface 81 and the bottom surface 82 and the lateral surfaces 83, 84 as can be seen by comparing FIG. 12b with FIG. 12c.

The abrading may alternatively result in flattened edges, in a sense creating an additional facet or additional surface 121b-124b at each edge, as shown on the abraded pultrusion 165a in FIG. 12d. As above, the width of the top surface 81 and the bottom surface 82 is shortened by the removal of parts of the edges.

Flattened edges can be simpler to produce since they can be made by cutting using for instance a rotating blade travelling along each of the edges. It is also possible to abrade for instance by grinding, planing, or sanding.

Abrading the edges makes it easier for instance to arrange the pultrusion plates in adjacent stacks, especially when the surface is sloped, in which case the edges of the adjacent pultrusion plates may come into contact with one another.

FIG. 12e illustrates an upper part of the abraded pultrusion plate 165a and shows the width W₁ of the top surface 81 and bottom surface 82 before abrading and the width W₂ of the top surface 81 and bottom surface 82 after abrading. Typically, the abrading reduces the width by 10-20 mm, that is, W₁-W₂ is in the range 10-20 mm. Typically, the reduction is distributed evenly between the two edges 121, 122 (see FIG. 12b), i.e. 5-10 mm is removed from each edge. The same applies to the bottom surface.

Removing parts of each of the edges is typically performed separately and may have been performed through the steps of:
abrading a first part of the top surface 81 within a first region of the top surface 81, the first region of the top surface 81 extending from the first lateral surface (83 towards the second lateral surface 84,
abrading a second part of the top surface 81 within a second region of the top surface 81, the second region of the top surface 81 extending from the second lateral surface 84 towards the first lateral surface 83,
abrading a first part of the bottom surface 82 within a first region of the bottom surface 82, the first region of the bottom surface 82 extending from the first lateral surface 83 towards the second lateral surface 84,
abrading a second part of the bottom surface 82 within a second region of the bottom surface 82, the second region of the bottom surface 82 extending from the second lateral surface 84 towards the first lateral surface 83.

In some embodiments, the abrading has a total longitudinal length or extent of at least half a length of the pultrusion plate. In some embodiments, the edges have been abraded along the entire length of the pultrusion plate. In some embodiments, abrading is not performed from an end of the pultrusion plate up to a distance in the range 100-1000 mm from said end, in particular in case the pultrusion plate is or will be chamfered at the end or ends. Abrading the end might compromise the strength of the chamfered end.

FIGS. 13a-13c illustrate a method for laying up abraded pultrusion plates for a wind turbine blade shell component, such as a spar cap. First, as shown in FIG. 13a, a first layer of one or more abraded pultrusion plates is arranged on a surface, such as on blade shell material arranged in a mould. In this case, the first layer contains a single abraded pultrusion plate 164a. An electrically conductive interlayer 131 is then placed on the first layer, as shown in FIG. 13b. Next, a second layer of one or more abraded pultrusion plates is place on the interlayer 131, in this case a single abraded pultrusion plate 164b. Subsequently, additional material may be arranged, as needed, and the layers are then bonded together with the surface, thereby forming the wind turbine blade shell component.

The interlayer 131 separates the two layers but provides electrical contact between the abraded pultrusion plates 164a and 164b by being in electrical contact with carbon fibre material in both abraded pultrusion plates.

The spar cap may include further abraded pultrusion plates, as shown in FIGS. 14a-14c. FIG. 14a illustrates arranging two abraded pultrusion plates 164a and 164c adjacent one another in a first layer. An electrically conductive interlayer 131 is arranged on top of the first layer of abraded pultrusion plates, as shown in FIG. 14b. Next, a second layer of abraded pultrusion plates 164b and 164d are arranged on the interlayer 131, forming a second layer.

The interlayer 131 in FIG. 14c separates the two layers but provides electrical contact between all the abraded pultrusion plates 164a-164d by being in electrical contact with carbon fibre material in the abraded pultrusion plates.

FIG. 15 illustrates the structure in FIG. 14c with an additional interlayer 132 placed on the second layer of abraded pultrusion plates and a third layer of abraded pultrusion plates 164e and 164f arranged on the second interlayer 132, resulting in two stacks of three abraded pultrusion plates.

The interlayers 131 and 132 provide electrical connection between all abraded pultrusion plates in the spar cap structure by electrically connecting the bottom surfaces of pultrusions in one layer, such as 164b and 164d, with the top surface of pultrusions in the layer below, such as 163a and 164c. Furthermore, electrical connection between the layers is established by the interlayers 131, 132. This is illustrated by the arrows going through carbon fibre material comprised in pultrusions 164c, 164b, 164d, 164e, 164f through the interlayers 131 and 132.

FIG. 16 illustrates a structure with four stacks of three abraded pultrusion plates, with an additional electrically conductive interlayer 133 separating the third and the fourth layer as counted from the layup surface.

The invention is not limited to the embodiments described herein and may be modified or adapted without departing from the scope of the present invention.

### LIST OF REFERENCE NUMERALS

4 tower
6 nacelle
8 hub
10 blades
14 blade tip
16 blade root
18 leading edge
20 trailing edge
30 root region
32 transition region
34 airfoil region
36 pressure side shell part
38 suction side shell part
40 shoulder
41 spar cap
42 fibre layers
43 sandwich core material
45 spar cap
46 fibre layers
47 sandwich core material
50 first shear web
51 core member
52 skin layers
55 second shear web
56 sandwich core material of second shear web
57 skin layers of second shear web
60 filler ropes
62 reinforcing structure
64 pultrusion plate
66 stack of pultrusion plates
67 path
68 tow of carbon fibre material
70 tow of glass fibre material
71 row of tows
72 column of tows
74 tip end of reinforcing structure
76 root end of reinforcing structure
77 mould
78 front edge of reinforcing structure
80 rear edge of reinforcing structure
81 top surface of pultrusion plate
82 bottom surface of pultrusion plate
83 first lateral surface of pultrusion plate
84 second lateral surface of pultrusion plate
85 core material
86 carbon biax layer
87 current connection terminal
88 bond line
89 shell material
90 pultrusion system
91 creel
92 bobbin with tow of glass fibre material
93 bobbin with tow of carbon fibre material
94 additional reinforcement material
95 guide plate
96 resin bath
97 heated die
98 pulling mechanism
99 cutter
100 pultrusion string
102 lightning protection system
104 down conductor
106 tip receptor
107 side receptor
108 side receptor
121-124: pultrusion plate edges
121a-124a: rounded edges from abrading
121b-124b: flattened edges/additional surfaces from abrading
131-132: electrically conductive interlayers
164a-164f: abraded pultrusion plates
165a: abraded pultrusion plate with flattened edges/additional surfaces
L length
l length of pultrusion plate
w width of pultrusion plate
h height of pultrusion plate
La longitudinal axis of pultrusion plate
r distance from hub
R rotor radius
Se spanwise extent of reinforcing structure
Ce chordwise extent of reinforcing structure

1-34. (canceled)

35. A lightning protection system (102) for a wind turbine blade, the lightning protection system comprising a lightning conductor (104) disposed at least partially in the interior of the blade, one or more electrically conductive lightning receptors (106, 107, 108) disposed on one or more of the surfaces of the blade, wherein the one or more electrically conductive lightning receptors are electrically connected to a spar cap,
wherein the spar cap comprises a plurality of abraded pultrusion plates (64) which have been obtained by abrading each of a first plurality of pultrusion plates, wherein each pultrusion plate (64) of the first plurality of pultrusion plates comprises a top surface (81), an opposing bottom surface (82), a first lateral surface (83) and an opposing second lateral surface (84), wherein the pultrusion plate is formed of a plurality of tows of carbon fibre material (68), and wherein adjoining tows of carbon fibre material are provided along the entire lateral surfaces (83, 84) of the pultrusion plate, and wherein the abrading of each of the first plurality of pultrusion plates to obtain the plurality of abraded pultrusion plates includes removing at least a part of each of the edges at which the top surface (81) meets the lateral surfaces (83, 84) and the edges at which the bottom surface (82) meets the lateral surfaces (83, 84), and wherein the abraded pultrusion plates are arranged into adjacent stacks of abraded pultrusion plates, wherein each pair of adjacent layers of abraded pultrusion plates in each stack are separated by an electrically conductive interlayer.

36. A lightning protection system according to claim 35, wherein each of the abraded pultrusion plates further comprises a plurality of tows of glass fibre material (70).

37. A lightning protection system according to claim 35, wherein removing at least a part of each of the edges includes steps of:
abrading a first part of the top surface (81) within a first region of the top surface (81), the first region of the top surface (81) extending from the first lateral surface (83) towards the second lateral surface (84),
abrading a second part of the top surface (81) within a second region of the top surface (81), the second region of the top surface (81) extending from the second lateral surface (84) towards the first lateral surface (83),
abrading a first part of the bottom surface (82) within a first region of the bottom surface (82), the first region of the bottom surface (82) extending from the first lateral surface (83) towards the second lateral surface (84),
abrading a second part of the bottom surface (82) within a second region of the bottom surface (82), the second region of the bottom surface (82) extending from the second lateral surface (84) towards the first lateral surface (83).

38. A method of manufacturing a wind turbine blade shell component (38), the method comprising the steps of:
providing a plurality of abraded pultrusion plates (64a-64f) obtained from a first plurality of pultrusion plates (64), wherein each pultrusion plate (64) in the first plurality of pultrusion plates comprises a top surface (81), an opposing bottom surface (82), a first lateral surface (83) and an opposing second lateral surface (84), wherein obtaining the plurality of abraded pultrusion plates includes abrading each of the first plurality of pultrusion plates by removing at least a part of each of the edges at which the top surface (81) meets the lateral surfaces (83, 84) and the edges at which the bottom surface (82) meets the lateral surfaces (83, 84),
arranging a first layer of abraded pultrusion plates (164a, 164c) on a blade shell material (89) in a mould (77),
arranging a first electrically conductive interlayer (131) on the first layer of abraded pultrusion plates,
arranging a second layer of abraded pultrusion plates (164b, 164d) on the first interlayer (131),
bonding the first and second layers of abraded pultrusion plates (164a-164d) with the blade shell material to form the blade shell component,
wherein each pultrusion plate (64) in the first plurality of pultrusion plates is formed of a pultrusion fibre material comprising a plurality of tows of carbon fibre material (68), and
wherein adjoining tows of carbon fibre material are provided along the lateral surfaces (83, 84) of the pultrusion plate.

39. A method according to claim 38, wherein each of the pultrusion plates further comprise a plurality of tows of glass fibre material (70).

40. A method according to claim 38, wherein removing at least a part of each of the edges at which the top surface (81) meets the lateral surfaces (83, 84) reduces a width of the top surface by 6-30 mm, such as by 10-30 mm, such as by 10-20 mm; and/or wherein removing at least a part of each of the edges at which the bottom surface (82) meets the lateral surfaces (83, 84) reduces a width of the bottom surface by 6-30 mm, such as by 10-30 mm, such as by 10-20 mm.

41. A method according to claim 38, wherein a total longitudinal length of each of the abraded parts is in the range [Lₚ-2000 mm, Lₚ,], where Lₚ is a longitudinal length of the abraded pultrusion plate.

42. A method according to claim 38, wherein the lateral surfaces of each pultrusion plate are free from glass fibres.

43. A method according to claim 42, wherein said lateral surfaces free from glass fibres are obtained by providing a continuous path of adjoining tows of carbon fibre material along the lateral edges of the pultrusion plate, the continuous path of adjoining tows of carbon fibre material extending from the top surface to the opposing bottom surface of the pultrusion plate, the continuous path of adjoining tows of carbon fibre material providing an electrically conductive path throughout the vertical direction of the pultrusion plate from the top surface to the bottom surface.

44. A method according to claim 38, wherein all tows of carbon fibre material within each abraded pultrusion plate are electrically coupled to one another.

45. A method according to claim 38, wherein the distance between adjoining tows of carbon fibre material is less than 50 μm.

46. A method according to claim 38, wherein the plurality of tows of glass fibre material and the plurality of tows of carbon fibre material form a non-random pattern, preferably a symmetrical pattern, as seen in a vertical cross section view of the pultrusion plate.

47. A method according to claim 38, wherein the abraded pultrusion plates are arranged into adjacent stacks of abraded pultrusion plates, and wherein adjoining tows of carbon fibre material together with the interlayers arranged between layers of the stacks, such as between all layers of the stacks, provide a conductive path from the top surface of the uppermost abraded pultrusion plate of a first stack of the adjacent stacks of pultrusion plates to the bottom surface of the lowermost abraded pultrusion plate in the first stack.

48. A method according to claim 38, wherein adjoining tows of carbon fibre material are provided along the top surface (81) of each pultrusion plate and wherein adjoining tows of carbon fibre material are provided along the bottom surface (82) of each pultrusion plate.

49. An abraded pultrusion plate (164a-164f, 165a), the abraded pultrusion plate having been obtained by abrading a first pultrusion plate having a top surface (81), an opposing bottom surface (82), a first lateral surface (83) and an opposing second lateral surface (84), wherein the first pultrusion plate is formed of a pultrusion fibre material comprising a plurality of tows of carbon fibre material (68), and wherein adjoining tows of carbon fibre material are provided along the entire lateral surfaces (83, 84) of the first pultrusion plate, and wherein the abrading of the first pultrusion plate to obtain the abraded pultrusion plate includes removing at least a part of each of the edges at which the top surface (81) meets the lateral surfaces (83, 84) and the edges at which the bottom surface (82) meets the lateral surfaces (83, 84) in the first pultrusion plate.

50. An abraded pultrusion plate in accordance with claim 49, wherein the abraded pultrusion plate further comprises a plurality of tows of glass fibre material (70).

51. An abraded pultrusion plate according to claim 49, wherein the lateral surfaces of the pultrusion plate are free from glass fibres, preferably by providing a continuous path of adjoining tows of carbon fibre material along the lateral edges of the pultrusion plate, the continuous path of adjoining tows of carbon fibre material extending from the top surface to the opposing bottom surface of the pultrusion plate.

52. An abraded pultrusion plate according to claim 49, wherein the plurality of tows of glass fibre material and the plurality of tows of carbon fibre material form a non-random pattern, preferably a symmetrical pattern, as seen in a vertical cross section of the pultrusion plate.

53. A reinforcing structure for a wind turbine blade, the reinforcing structure comprising layers of abraded pultrusion plates (164a-164f, 165a) according to claim 49, wherein the abraded pultrusion plates are arranged into adjacent stacks of abraded pultrusion plates, each pair of layers of abraded pultrusion plates in each stack being separated by an electrically conductive interlayer (131, 132).

54. A wind turbine blade shell component comprising a reinforcing structure in accordance with claim 53.
